(19) United States
(12) Patent Application Publication
(10) Pub. No.: US 2010/0307615 A1
(43) Pub. Date: Dec. 9, 2010

(54) FUEL SUPPLY DEVICE

(75) Inventors: Hideaki Takahashi, Kanagawa (JP); Toshihide Kimisawa, Kanagawa (JP); Hiromasa Suzuki, Aichi (JP)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: NIFCO INC., Kanagawa (JP)

(21) Appl. No.: 12/746,034

(22) PCT Filed: Dec. 4, 2008
(86) PCT No.: PCT/JP2008/072059

§ 371 Date: Aug. 3, 2010

(30) Foreign Application Priority Data
Dec. 4, 2007 (JP) 2007-313587

(51) Int. Cl. B01D 29/00

(52) U.S. Cl. 137/544

(57) ABSTRACT

On an inner circumference wall of a connecting pipe, a step is arranged at a lower portion of a through hole so that the inner diameter on the side of a suction port of a fuel pump is larger than that on the side of a nozzle section of a filter member. Thus, flow into the side of the nozzle section of the filter member is suppressed by making a subsidiary stream flowing from a sub channel into a confluence section not easily flow into the side having the smaller inner diameter.

### CROSS-REFERENCE TO RELATED APPLICATION

This application is the National Stage of International Application no. PCT/JP2008/072059 filed Dec. 4, 2008, which claims the benefit of Japanese patent application number 2007-313587 filed Dec. 4, 2007, the contents of which are incorporated by reference herein.

### FIELD OF THE INVENTION

The present invention relates to a fuel supply device for supplying fuel inside a fuel tank to an engine.

### BACKGROUND

In an automobile fuel tank, a circulation tank is provided, and a fuel pump, for sucking in fuel of the fuel tank and for supplying the same to an engine, is disposed in the circulation tank and supplies the fuel to the engine via a feed pipe. Configuration is made, in such cases, such that excess fuel is returned, as return fuel, via a return pipe to the circulation tank in the fuel tank as, for example, in Japanese Patent Application Laid Open (JP-A) No. 9-4537 and JP-A No. 7-180632.

A filtration device is provided to the circulation tank, and the filtration device is connected to a suction inlet of the fuel pump, such that fuel in the fuel tank is sucked into the fuel pump in a state filtered by a filter in the filtration device.

### SUMMARY

The present invention provides a fuel supply device that reduces the load of a fuel pump, and can achieve a raised life performance and compactness of a filter member.

A first aspect of the present invention provides a fuel supply device equipped with: a fuel pump, provided inside a fuel tank and sucking up fuel inside the fuel tank; a filter member, connected at a side of a suction inlet of the fuel pump and filtering the fuel inside the fuel tank; and a circulation path, through which excess fuel from the fuel sucked up by the fuel pump flows, and connected to a connecting pipe provided between the suction inlet of the fuel pump and the filter member. The connecting pipe is configured including: a main flow path that makes fuel filtered by the filter member flow towards the suction inlet of the fuel pump; a confluence section that combines the flow of excess fuel in the circulation path with the flow in the main flow path; and a restriction portion, provided to the confluence section so as to restrict excess fuel flowing from the circulation path into the main flow path from flowing towards the filter member side.

In the above aspect, the fuel pump that sucks up fuel inside the fuel tank is provided inside the fuel tank. The filter member is connected at the side of the suction inlet of the fuel pump and filters the fuel inside the fuel tank. Then excess fuel, from the fuel sucked up by the fuel pump, flows in a circulation path so as to be returned into the connecting pipe provided between the suction inlet of the fuel pump and the filter member. Due thereto, excess fuel does not re-pass through the filter member.

Fuel flowing in the circulation path has already passed through the filter member, and is fuel that has completed filtration. Therefore, by returning the fuel in the circulation path to the connecting pipe positioned at the downstream side of the filter member, as well as extending the life of the filter member, the life of the fuel pump can also be extended by reducing the load of the fuel pump.

Furthermore, since it is possible to make the filter surface area of the filter member smaller, the filter member can be made more compact. Reducing the pump load of the fuel pump also enables a highly sensitive filtration member to be employed in the filter member. Accordingly, it is also possible to dispense with the filter member on the downstream side of the fuel pump.

The connecting pipe here is equipped with the main flow path, which makes fuel filtered by the filter member flow towards the suction inlet of the fuel pump, and the confluence section, which combines the flow of excess fuel in the circulation path with the flow in the main flow path. The restriction portion is also provided to the confluence section with the subsidiary flow (excess fuel) flowing from the circulation path into the main flow path restricted by the restriction portion from flowing towards the filter member side.

Due thereto, disturbance in liquid pressure due to turbulent flow, between the main flow, flowing from the filter member via the main flow path of the connecting pipe towards the side of the suction inlet port of the fuel pump, and the subsidiary flow, flowing from the circulation path via the connecting pipe towards the suction inlet port of the fuel pump, is reduced, and fuel that has passed through the filter member and excess fuel can be efficiently stabilized and supplied to the suction inlet port of the fuel pump.

By, in this manner, reducing back flow of the subsidiary flow, flowing from the circulation path towards the connecting pipe, towards the filter member, configuration can be made such that the total amount of fuel in the circulation path is fed towards the fuel pump side, and such that the flow of the main flow flowing in the main flow path is not impeded. Accordingly, since the liquid pressure of fuel in the circulation path can be transmitted unaffected to the suction inlet port of the fuel pump, load (current) of the fuel pump can be reduced, and the pump lifespan can also be extended.

Furthermore, since fuel from the circulation path increases the liquid pressure towards the suction inlet port of the fuel pump, a reduced pressure state does not readily arise in the vicinity of the suction inlet port of the fuel pump, and operational problems in the fuel pump, due to bubbles developing from reduced pressure boiling, do not readily occur.

A second aspect of the present invention is the first aspect of the present invention, wherein the restriction portion may be a step having an inner diameter dimension at the filter member side smaller than at the side of the suction inlet of the fuel pump.

According to the above aspect, the step is provided to the confluence section combining the subsidiary flow from the circulation path with the main flow flowing in the main flow path, and the inner diameter dimension at the side of the filter member is made smaller than at the side of the suction inlet port of the fuel pump. In other words, by making the main flow path a smaller diameter using the step, the flow amount of fuel flowing in the main flow path is lessened, and the main flow and the subsidiary flow are combined in a state in which there is little resistance from the main flow. Accordingly, the subsidiary flow is suppressed from backflow towards the filter member side.

Further, by providing the step, since the flow velocity in the main flow path is raised, suction force in the main flow can be generated thereby, and the subsidiary flow that has flowed into the confluence section can be guided towards the side of the suction inlet port of the fuel pump.

A third aspect of the present invention is the first aspect of the present invention, configured such that an axial line of the main flow path maybe does not intersect with an axial line of a connection portion of the circulation path for connecting to the connecting pipe.

In cases where the axial line of the main flow path (main flow) intersects with the axial line of the connection portion of the circulation path (subsidiary flow), the subsidiary flow would directly impinge on the main flow. Consequently, by configuring as described above, configuration is made such that the subsidiary flow and the main flow do not directly impinge on each other, by making the axial line of the main flow path and the axial line of the connection portion of the circulation path not intersect with each other.

Further, by making the axial line of the main flow path and the axial line of the connection portion of the circulation path not intersect with each other, the subsidiary flow is guided above the step provided to the confluence section, so as to trace a circular arc around the inner peripheral wall of the confluence section (vortex shape, spiral shape), and combine with the main flow.

As stated above, due to the smaller flow amount of the main flow due to the step, there is little influence on the spiral shape of the fuel that has flowed in from the subsidiary flow due to the main flow, and the subsidiary flow can be efficiently combined with the main flow. Since the main flow has a smaller diameter, a state is achieved in which the fuel that has flowed in from the subsidiary flow is preferentially sucked into the fuel pump. Due thereto, the flow amount sucked in from the filter member is less, extending the life of the filter member.

A fourth aspect of the present invention is the second aspect of the present invention, wherein a step face of the step may be a spiral shape that guides excess fuel to be combined from the circulation path with the main flow path, so as to be guided along the inside wall of the confluence section towards the side of the suction inlet of the fuel pump.

According to the above configuration, by making the step face of the step a spiral shape that guides excess fuel, to be combined from the circulation path with the main flow path, along the inside wall of the confluence section towards the side of the suction inlet of the fuel pump, the excess fuel guided above the step can be efficiently guided towards the side of the suction inlet of the fuel pump.

A fifth aspect of the present invention is the first aspect of the present invention, wherein the connecting pipe is integrally provided to the filter member.

According to the above configuration, by integrally providing the connecting pipe to the filter member, the number of components can be reduced, and also the number of operations accompanying connecting each of the members can be reduced.

Due to the present invention being configured as described above, the load of the fuel pump is reduced, and raised life performance and compactness of the filter member can be achieved.

### BRIEF DESCRIPTION OF THE DRAWINGS

FIG. 1 is an overall configuration diagram of a fuel supply device according to an exemplary embodiment of the present invention.

FIG. 2 is an enlarged diagram of relevant portions of a fuel supply device according to an exemplary embodiment of the present invention.

FIG. 3 is an outline plan view of a connecting pipe configuring a fuel supply device according to an exemplary embodiment of the present invention.

FIG. 4 is a perspective view of a cross-section of a connecting pipe configuring a fuel supply device according to an exemplary embodiment of the present invention.

FIG. 5 is a perspective view of a cross-section of a connecting pipe configuring a fuel supply device according to an exemplary embodiment of the present invention.

FIG. 6 is a perspective view of a cross-section showing a modified example of a connecting pipe configuring a fuel supply device according to an exemplary embodiment of the present invention.

FIG. 7 is an overall configuration diagram of a circulation-less type.

FIG. 8 is an overall configuration diagram of an evaluation test of a fuel supply device according to an exemplary embodiment of the present invention.

FIG. 9 is a graph showing test results.

### DESCRIPTION OF PREFERRED EMBODIMENTS

Next, explanation follows regarding a fuel supply device according to an exemplary embodiment of the present invention.

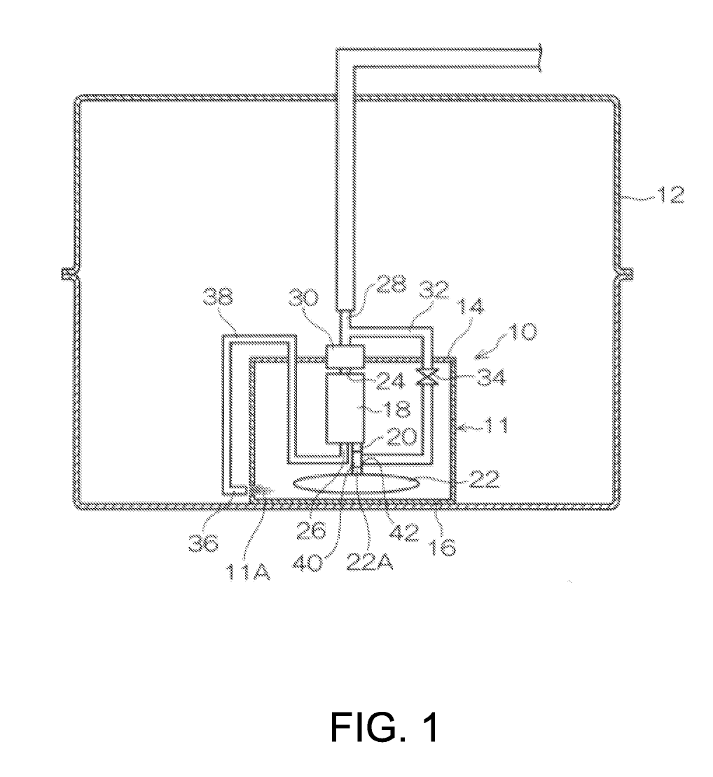

As shown in FIG. 1, a reservoir cup 11 with a fuel supply device 10 disposed therein is provided to a bottom section of a fuel tank 12 of an automobile, such that fuel (gasoline) supplied into the fuel tank 12 is flowed into the reservoir cup 11 by a fuel pump 18 configuring the fuel supply device 10.

One end of a substantially circular cylindrical shaped connecting pipe 40 (described below) is connected to a suction inlet port 20 of the fuel pump 18, and a nozzle section 22A provided to a filter member 22 is connected to the other end of the connecting pipe 40. The filter member 22 filters fuel that has flowed into the reservoir cup 11 from the fuel tank 12, and is capable of removing dirt, foreign objects and the like.

Outlet ports 24, 26 of the fuel pump 18 branch at two locations, with one outlet port 26 provided at a lower portion of the fuel pump 18 and connected to a jet nozzle pipe 38 having a jet nozzle 36 provided at a distal end portion thereof.

The jet nozzle pipe 38 leads from the outlet port 26 of the fuel pump 18, through a lid section 14 of the reservoir cup 11 to first pass outside of the reservoir cup 11 and run inside the fuel tank 12, and then the jet nozzle 36 at the distal end injects fuel towards an opening 11A provided in a lower section of a peripheral wall of the reservoir cup 11. Thereby, the pressure in the vicinity of the opening 11A becomes a negative pressure, and fuel in the fuel tank 12 flows through the opening 11A into the reservoir cup 11 along with the injection of the jet nozzle 36.

The other outlet port 24 is provided at an upper section of the fuel pump 18, and a main pipe 28 is connected to the outlet port 24. Fuel is fed to the engine room by the main pipe 28. A filter member 30 is provided to the main pipe 28, enabling fine dirt or the like that could not be filtered by the filter member 22 to be removed by the filter member 30.

A return pipe (circulation path) 32 branches from the main pipe 28, and a pressure regulator 34 is provided to the return pipe 32. The pressure in the main pipe 28 is regulated so as to be constant by a valve of the pressure regulator 34 opening if the pressure in the main pipe 28 exceeds a specific pressure, such that excess fuel is returned into the reservoir cup 11 through the return pipe 32 when this valve is open.

As stated above, the suction inlet port 20 of the fuel pump 18 here is connected to one end of the connecting pipe 40, and the nozzle section 22A of the filter member 22 is connected to the other end of the connecting pipe 40, however, the one end and the other end of the connecting pipe 40 are disposed on the same straight line, with a through hole 42 formed in the outer peripheral face of the connecting pipe 40 between the one end and the other end of the connecting pipe 40.

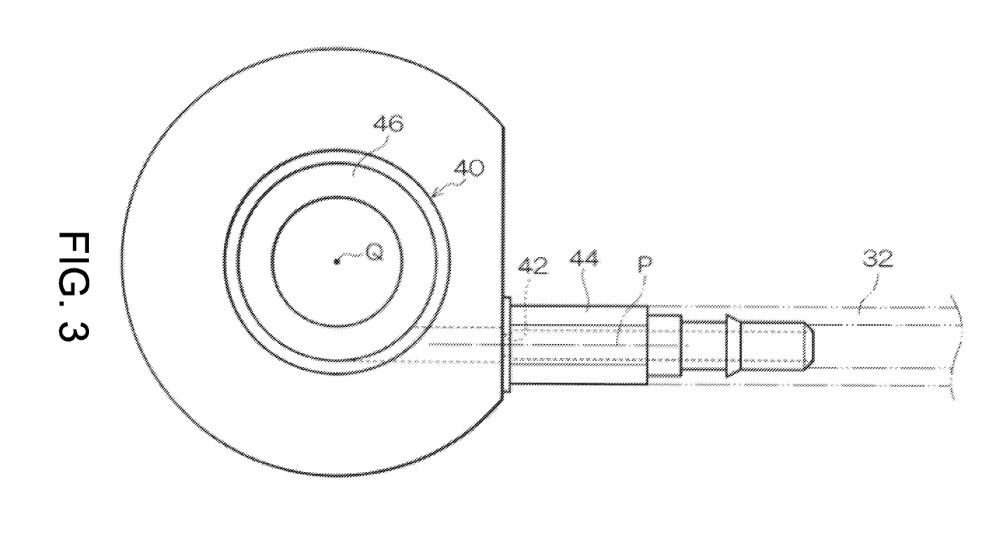

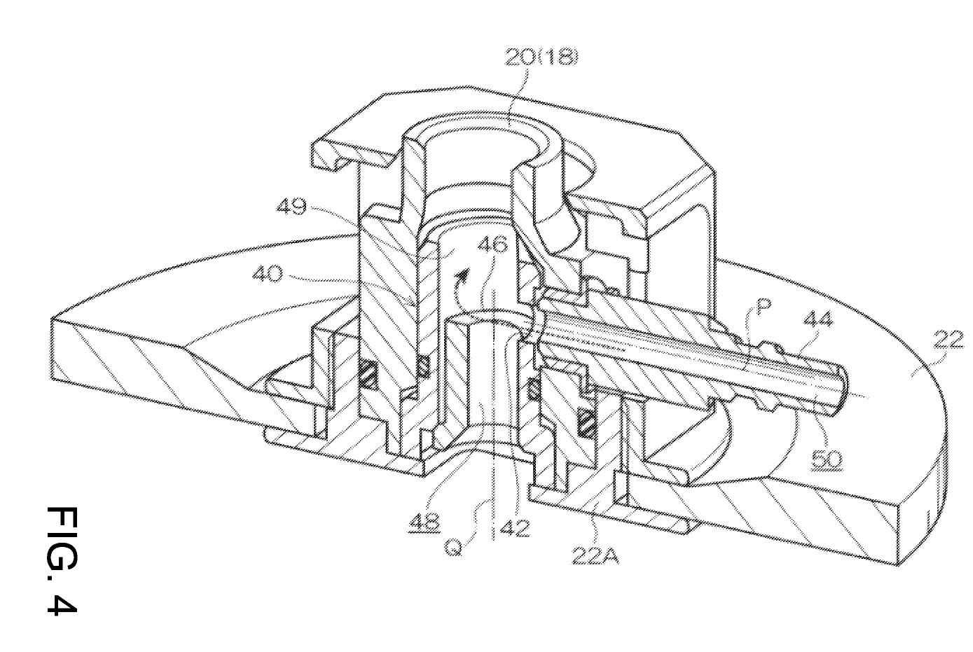

The through hole 42, as shown in FIG. 3 and FIG. 4, is formed such that the center line P of the through hole 42 (the axial line of the connection portion of the circulation path) does not intersect with the axial line Q of the connecting pipe 40 (the axial line of the main flow path), a joint (connection portion) 44 is fitted to the through hole 42, and the distal end of the return pipe 32 is connected to the connecting pipe 40 via the joint 44. Consequently, excess fuel flows via the return pipe 32 from the through hole 42 into the connecting pipe 40, so as to be guided through the connecting pipe 40 towards the suction inlet port 20 of the fuel pump 18.

A step (restriction portion) 46 is provided to the inner peripheral wall of the connecting pipe 40 at a lower portion of the through hole 42, such that the inner diameter dimension at the side of the nozzle section 22A of the filter member 22 is smaller than the inner diameter dimension at the side of the suction inlet port 20 of the fuel pump 18.

The flow path here (on the line extending from the small diameter section of the inner peripheral wall of the connecting pipe 40) from the nozzle section 22A of the filter member 22 towards the suction inlet port 20 of the fuel pump 18 configures a main flow path 48, and a large diameter section of the inner peripheral wall of the connecting pipe 40 configures a confluence section 49. The flow path guiding from the return pipe 32 towards the confluence section 49 of the connecting pipe 40 configures a subsidiary flow path (circulation path) 50, and fuel in the subsidiary flow path 50 combines with the main flow path 48 at the confluence section 49, and is sucked into the suction inlet port 20 of the fuel pump 18.

### Operation and Effect

Next, explanation follows regarding the operation of a fuel supply device according to an exemplary embodiment of the present invention.

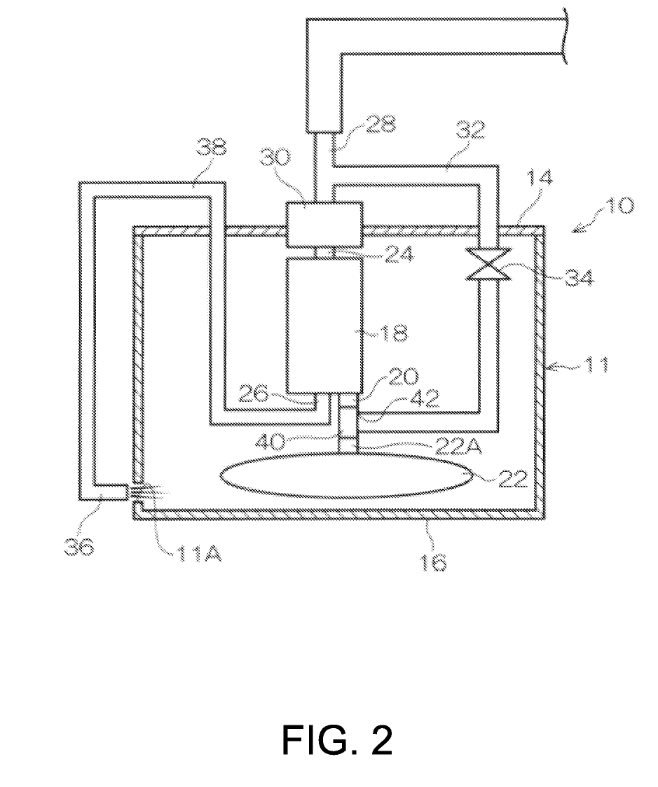

As shown in FIG. 2, the present exemplary embodiment is configured such that excess fuel from the fuel sucked up by the fuel pump 18 is returned via the return pipe 32 into the connecting pipe 40 provided between the suction inlet port 20 of the fuel pump 18 and the nozzle section 22A of the filter member 22. Accordingly, configuration is such that excess fuel does not re-pass through the filter member 22.

Fuel flowing in the return pipe 32 has already passed through the filter member 22, and is fuel that has completed filtration. Therefore, by returning the fuel in the return pipe 32 to the connecting pipe 40 positioned at the downstream side of the filter member 22, and, as well as extending the life of the filter member 22, the life of the fuel pump 18 can be extended by reducing the load of the fuel pump 18.

Furthermore, since it is possible to make the filter surface area of the filter member 22 smaller, the filter member 22 can be made more compact. By reducing the pump load of the fuel pump 18, it is also possible to employ a highly sensitive filtration member in the filter member 22. Accordingly, it is also possible to dispense with the filter member 30 on the downstream side of the fuel pump 18.

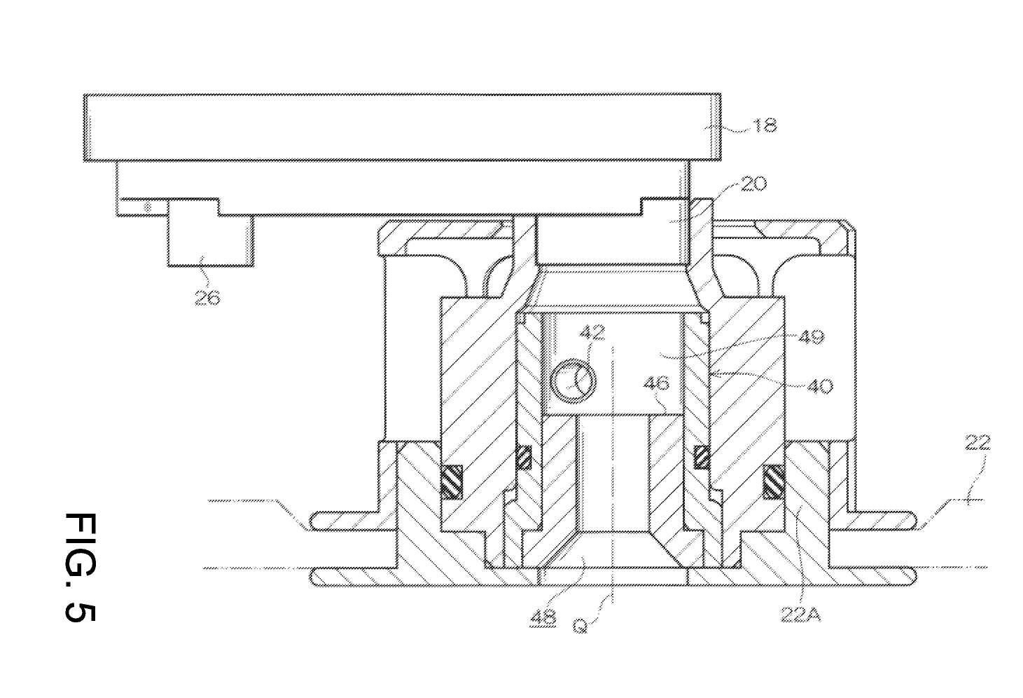

The step 46 is, as shown in FIG. 4 and FIG. 5, provided to the inner peripheral wall of the connecting pipe 40 at a lower portion of the through hole 42, and the inner diameter dimension at the side of the nozzle section 22A of the filter member 22 is made smaller than the inner diameter dimension at the side of the suction inlet port 20 of the fuel pump 18. In other words, by making the main flow path 48 a smaller diameter using the step 46, the flow amount of fuel flowing in the main flow path 48 is lessened, and the main flow and the subsidiary flow are combined in a state in which there is little resistance from the main flow. Accordingly, the subsidiary flow is suppressed from backflow towards the filter member side.

Due thereto, disturbance in liquid pressure due to turbulent flow, between the main flow (fuel), flowing from the nozzle section 22A of the filter member 22 into the main flow path 48 of the connecting pipe 40 towards the side of the suction inlet port 20 of the fuel pump 18, and the subsidiary flow (excess fuel), flowing from the subsidiary flow path 50 of the connecting pipe 40 through the confluence section 49 towards the suction inlet port 20 of the fuel pump 18, is reduced, and excess fuel and fuel that has passed through the filter member 22 can be efficiently supplied to the suction inlet port 20 of the fuel pump 18, enabling the load of the fuel pump 18 to be reduced.

Further, by providing the step 46, since the flow velocity in the main flow path 48 is raised, suction force in the main flow can be generated thereby, and the subsidiary flow that has flowed into the confluence section 49 can be guided towards the side of the suction inlet port 20 of the fuel pump 18.

Due to the above, the total amount of excess fuel in the return pipe 32 can be fed towards the fuel pump 18 side by reducing back flow of the subsidiary flow, flowing from the subsidiary flow path 50 towards the main flow path 48, towards the side of the nozzle section 22A of the filter member 22, such that the flow of the main flow flowing in the main flow path 48 is not impeded.

Accordingly, since the liquid pressure of fuel in the return pipe 32 can be transmitted unaffected to the suction inlet port 20 of the fuel pump 18, load (current) of the fuel pump 18 can be reduced, and the pump lifespan can also be extended.

Furthermore, since fuel from the return pipe 32 applies the liquid pressure towards the suction inlet port 20 of the fuel pump 18, a reduced pressure state does not readily arise in the vicinity of the suction inlet port 20 of the fuel pump 18, and operational problems in the fuel pump 18, due to bubbles developing from reduced pressure boiling, do not readily occur.

The through hole 42 is also provided here such that the axial line P of the joint 44 (axial line P of the subsidiary flow path 50) does not intersect with the axial line Q of the connecting pipe 40 (axial line Q of the main flow path 48). In cases where the axial line Q of the main flow path 48 intersects with the axial line P of the subsidiary flow path 50, the subsidiary flow (fuel flowing from the subsidiary flow path 50 into the confluence section 49) would directly impinge on the main flow (fuel flowing in the main flow path 48).

Consequently, in the present exemplary embodiment, the axial line P of the subsidiary flow path 50 is configured so as not to intersect with the axial line Q of the main flow path 48, in order that the subsidiary flow does not directly impinge on the main flow. Due thereto, the subsidiary flow is expelled from the through hole 42 and guided above the step 46 provided to the confluence section 49, so as to trace a circular arc around the inner peripheral wall inside the main flow path 48 (vortex shape, spiral shape), and combine with the main flow.

As stated above, due to the flow amount of the main flow is reduced by the step 46, there is little influence on the spiral shape of the fuel that has flowed in from the subsidiary flow due to the main flow, and the subsidiary flow can be efficiently combined with the main flow. Further, since the main flow has a smaller diameter, a state is achieved in which the fuel that has flowed in from the subsidiary flow is preferentially sucked into the fuel pump 18. Due thereto, the flow amount sucked in from the filter member 22 is less, extending the life of the filter member 22.

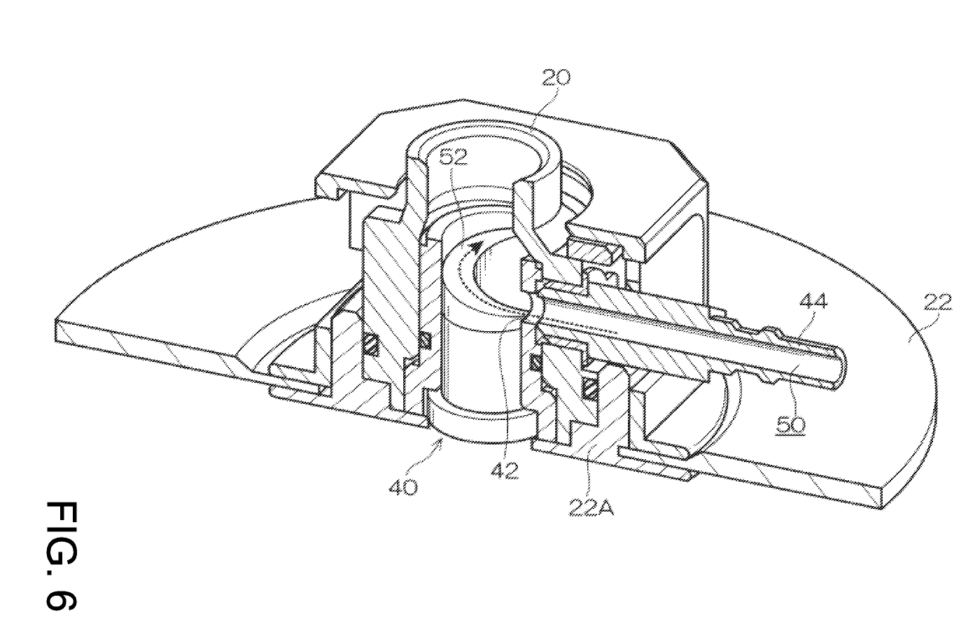

Note that in the present exemplary embodiment, as shown in FIG. 4, the step 46 is provided to the inner peripheral wall of the connecting pipe 40 by changing the inner diameter dimension of the main flow path 48 and the confluence section 49 of the connecting pipe 40, however, as shown in FIG. 6, configuration may be made by providing a step (restriction portion) 52 having a sloping step face, such that the step 52 is formed in a vortex shape (spiral shape) facing from a lower portion of the through hole 42 towards the side of the suction inlet port 20 of the fuel pump 18. Due thereto, fuel that has been guided via the through hole 42 to above the step 52 can be efficiently guided to the side of the suction inlet port 20 of the fuel pump 18.

Further, while not shown in the drawings, a joint may be provided inclined to the axial line P of the connecting pipe 40 such that fuel being expelled from the through hole 42 faces diagonally upwards inside the confluence section 49.

Furthermore, while the through hole 42 in the current case is formed in the outer peripheral face of the connecting pipe 40, the joint 44 is fitted to the through hole 42, and the distal end of the return pipe 32 is connected to the connecting pipe 40 via the joint 44, as long as the suction inlet port 20 of the fuel pump 18, the nozzle section 22A of the filter member 22, and the distal end of the return pipe 32 are each respectively connected to the connecting pipe 40, configuration may be with the joint 44 integrally formed to the through hole 42 of the connecting pipe 40.

Furthermore, while the suction inlet port 20 of the fuel pump 18 is connected to one end of the connecting pipe 40, so as to connect the nozzle section 22A of the filter member 22 to the other end of the connecting pipe 40, the connecting pipe 40 may be integrally provided to the nozzle section 22A of the filter member 22.

### Test Results

Next, the following tests were performed in order to evaluate the fuel supply device according to exemplary embodiments of the present invention.

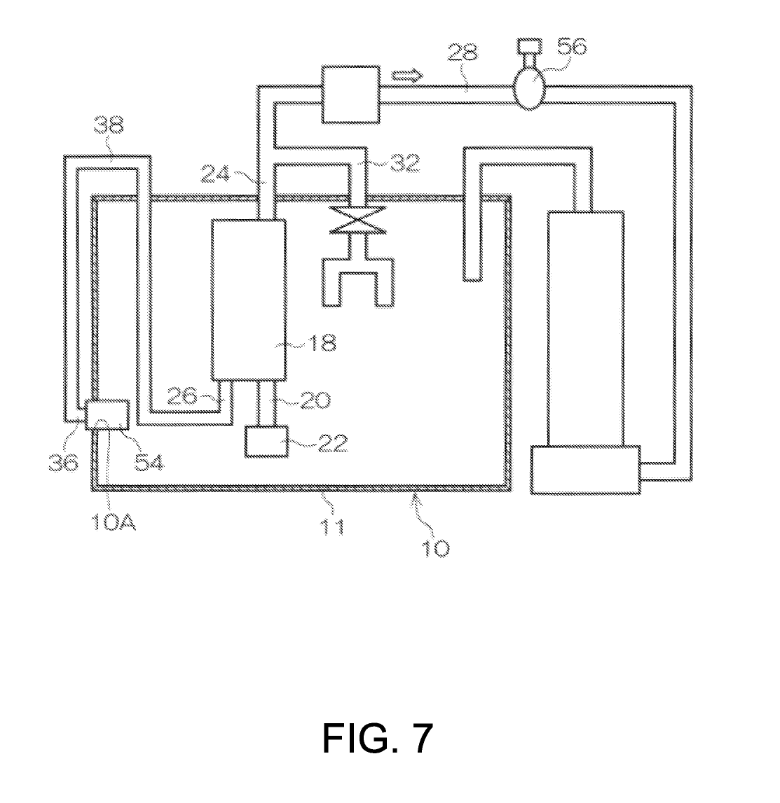

As fuel circulation system was prepared with the reservoir cup 11 as shown in FIG. 7, and tests performed on the circulation system. Here, the jet nozzle 36 provided at the distal end of the jet nozzle pipe 38, that expels fuel from the outlet port 26 of the fuel pump 18, is connected to a connector 54 passing through to inside the reservoir cup 11, provided at the opening 11A formed in the peripheral wall of the reservoir cup 11, such that fuel ejected from the jet nozzle 36 is made to flow directly into the reservoir cup 11.

Further, fuel expelled from the outlet port 24 of the fuel pump 18 and conventionally fed towards an engine room is also configured so as to be returned to the reservoir cup 11. Then, a flow regulation valve 56 is provided to the main pipe 28, such that the flow amount in the main pipe 28 can be varied according to conditions of a vehicle, such as during idling, during normal running, during high speed running, and the like.

For example, in a compact car of less than 1500 cc, the flow amount of the main pipe 28 during idling is 1 L/hr, the flow amount in the main pipe 28 during normal running is 10 L/hr, and the flow amount in the main pipe 28 during high speed running is 30 L/hr.

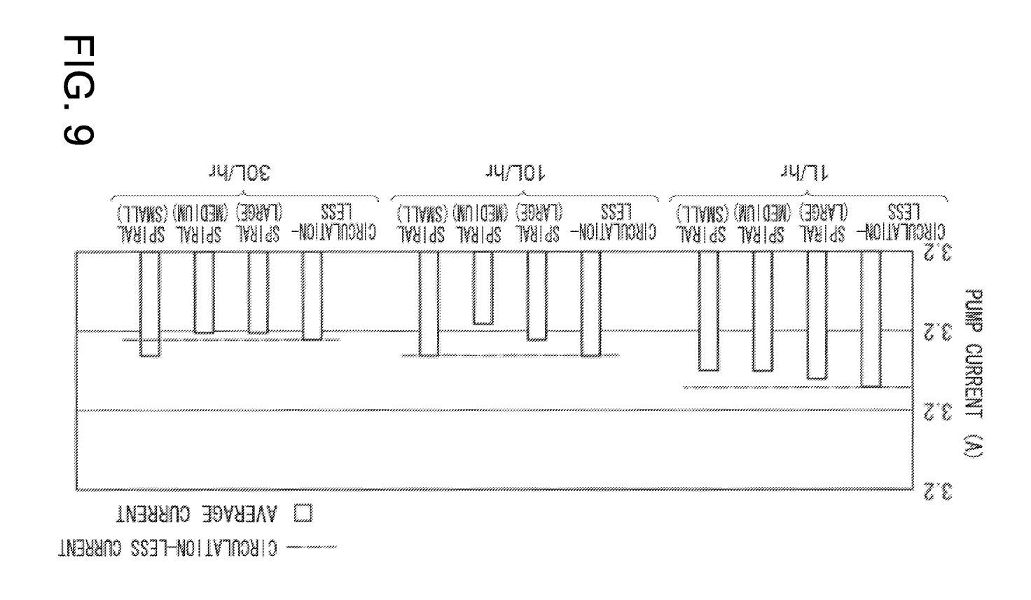

Then, the voltage load of the fuel pump 18 is set at 12V and each test is performed, with varying flow amounts in the main pipe 28 using the flow regulation valve 56. At such a time, an ammeter is provided to the fuel pump 18, such that the current flowing in the fuel pump 18 is measured during operation of the fuel pump 18. The results derived thereby are shown in FIG. 9.

The circulation-less type here, as shown in FIG. 7, is configured with the return pipe 32 not connected to the connecting pipe 40, but simply returning to inside the reservoir cup 11, such that the fuel in the return pipe 32 is re-filtered by the filter member 22. In other words, fuel passing through the suction inlet port 20 of the fuel pump 18 is always fuel that has just passed through the filter member 22.

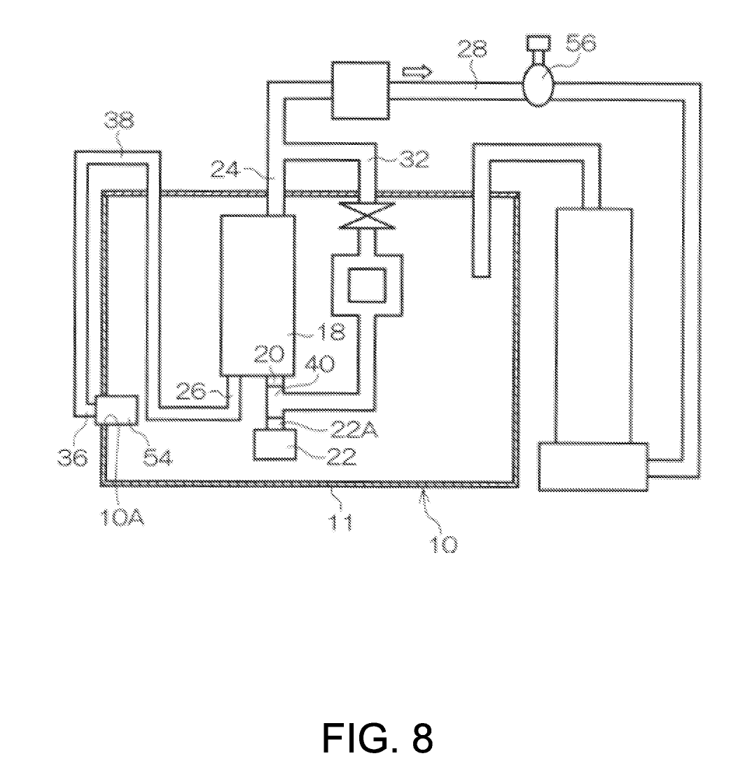

In contrast, in a circulation type, as shown in FIG. 8, the return pipe 32 is connected to the connecting pipe 40. Then, as shown in FIG. 4, by providing the step 46 to the confluence section 49 of the connecting pipe 40 and configuring such that the axial line P of the subsidiary flow path 50 does not intersect with the axial line Q of the connecting pipe 40, the fuel from the subsidiary flow is made to flow inside the main flow path 48 in a spiral shape along the inner peripheral wall, so as to be combined with the main flow.

Here, the inner diameter dimension of the confluence section 49 of the connecting pipe 40 is φ 8.2 mm, the inner diameter dimension of the through hole 42 is φ 2.2 mm, in a spiral (large) the inner diameter dimension of the main flow path 48 is φ 6.2 mm, in a spiral (medium) the inner diameter dimension of the main flow path 48 is φ 4.2 mm, and in a spiral (small) the inner diameter dimension of the main flow path 48 is φ 3.0 mm.

FIG. 9 is a comparison graph showing the pump current in a circulation type against the pump current in a circulation-less type (shown by the single dotted lines), with the results by spiral type (large), (medium) and (small) shown respectively for the circulation type.

It can be seen thereby that the pump current is lower in cases of the spiral type (large) and (medium), in comparison to that of the circulation-less type, irrespective of the flow amount of fuel flowing in the main pipe 28. However, in the case of the spiral type (small), in a state in which the flow amount is restricted, such as during idling or the like, the pump flow amount is less in comparison to that of the circulation-less type and the spiral type (large), (medium), however, when the flow amount of the fuel flowing in the main pipe 28 is increased, the pump current becomes greater than that of the circulation-less type.

This is due to the relationship between the flow velocity of the fuel flowing in the main flow path 48 and the flow velocity of the fuel flowing from the subsidiary flow path 50 into the confluence section 49, and a difference is preferably provided in the flow velocities between the fuel in the main flow path 48 and the fuel in the subsidiary flow path 50.

1. A fuel supply device comprising:
a fuel pump, provided inside a fuel tank and that sucks up fuel inside the fuel tank;
a filter member, connected at a side of a suction inlet of the fuel pump and filtering the fuel inside the fuel tank; and
a circulation path, through which excess fuel from the fuel sucked up by the fuel pump flows, and which is connected to a connecting pipe provided between the suction inlet of the fuel pump and the filter member,
the connecting pipe comprising:
a main flow path that makes fuel filtered by the filter member flow towards the suction inlet of the fuel pump;
a confluence section that combines the flow of excess fuel in the circulation path with the flow in the main flow path; and
a restriction portion, provided to the confluence section so as to restrict excess fuel flowing from the circulation path into the main flow path from flowing towards the filter member side.

2. The fuel supply device of claim 1, wherein the restriction portion is a step having an inner diameter dimension at the filter member side that is smaller than that at the side of the suction inlet of the fuel pump.

3. The fuel supply device of claim 1, wherein an axial line of the main flow path does not intersect with an axial line of a connection portion of the circulation path that is connected to the connecting pipe.

4. The fuel supply device of claim 2, wherein a step face of the step is a spiral shape that guides excess fuel from the circulation path to be combined into the main flow path, such that the excess fuel is guided along the inside wall of the confluence section towards the side of the suction inlet of the fuel pump.

5. The fuel supply device of claim 1, wherein the connecting pipe is integrally provided to the filter member.
